(19) United States
(12) Patent Application Publication
(10) Pub. No.: US 2022/0386181 A1
(43) Pub. Date: Dec. 1, 2022

(54) METHODS FOR RESOURCE RESERVATION IN MMTC AND RELATED APPARATUS

(71) Applicant: Telefonaktiebolaget LM Ericsson (publ), Stockholm (SE)

(72) Inventors: Mohammad Mozaffari, FREMONT, CA (US); Johan Bergman, STOCKHOLM (SE); Anders Wallén, YSTAD (SE); Mattias Frenne, UPPSALA (SE)

(21) Appl. No.: 17/770,506

(22) PCT Filed: Nov. 4, 2020
(86) PCT No.: PCT/SE2020/051059

§ 371 Date: Apr. 20, 2022

Related U.S. Application Data
(60) Provisional application No. 62/933,328, filed on Nov. 8, 2019.

(51) Int. Cl. H04W 28/26; H04W 4/70

(52) U.S. Cl. CPC H04W 28/26; H04W 4/70

(57) ABSTRACT

A method performed by a network node in a communication network is provided. The method includes configuring a time-domain resource reservation for use in communication with a massive machine-type communication, mMTC, communication device when coexisting with a new radio system or a Long-Term Evolution system. The time-domain resource reservation includes a first bitmap having bits representing the resource reservation in consecutive slots and the first bitmap indicates one of a slot-level resource reservation and a symbol-level resource reservation. The method further includes signaling an indication of the time-domain resource reservation to the mMTC communication device. A method performed by a mMTC communication device is also provided.

### TECHNICAL FIELD

The present disclosure relates generally to communications, and more particularly to communication methods and related devices and nodes supporting massive machine-type communication (mMTC).

### BACKGROUND

Machine-type communications are widely used in many applications such as vehicle tracking, user and home security, banking, remote monitoring and smart grid. According to the latest edition of Ericsson mobility report (ericsson.com/en/mobility-report/reports/June-2019), by 2023 there will be 3.5 billion wide-area devices connected to cellular networks. In this regard, Long-Term Evolution for Machine-Type Communications (LTE-M) (also known as LTE-MTC or eMTC) and narrowband Internet-of-Things (NB-IoT) technologies are being rolled out at a fast pace, and it is foreseen that in the next few years, a massive number of devices will be connected to the networks, addressing a wide spectrum of LTE-M and NB-IoT use cases. Thanks to a design that enables 10-year battery lifetime of LTE-M and NB-IoT devices, many of these devices will remain in service years after deployment. During the lifetime of these deployed devices, many networks may undergo Long Term Evolution (LTE) to New Radio (NR) migration. A smooth migration without causing service interruption to the deployed LTE-M and NB-IoT devices is important to mobile network operators (MNO).

### SUMMARY

According to some embodiments of the present disclosure, a method of operating a network node in a communication network is provided. The method includes configuring a time-domain resource reservation for use in communication with a massive machine-type communication, mMTC, communication device when coexisting with a new radio system or a Long-Term Evolution system. The time-domain resource reservation includes a first bitmap having bits representing the resource reservation in consecutive slots and the first bitmap indicates one of a slot-level resource reservation and a symbol-level resource reservation. The method further includes signaling an indication of the time-domain resource reservation to the mMTC communication device.

In some embodiments of the present disclosure, a method of operating a massive machine-type communication, mMTC, communication device in a communication network is provided. The method includes receiving, from a network node, an indication of a time-domain resource reservation for use in communication with the network node. The time-domain resource reservation includes a first bitmap having bits representing the resource reservation in consecutive slots and the first bitmap indicates one of a slot-level resource reservation and a symbol-level resource reservation. The method further includes communicating with the network node in accordance with the received indication of the time-domain reservation.

Corresponding embodiments of inventive concepts for network node, a massive machine-type communication device, computer products, and computer programs are also provided.

The following explanation of potential problems with existing solutions is a present realization as part of the present disclosure and is not to be construed as previously known by others. Some approaches for resource reservation operations do not provide flexibility to efficiently configure and reserve mMTC time-domain resources when coexisting with another system, such as NR. As a consequence, overhead associated with resource reservation may not be efficiently controlled and flexibility for configuring and reserving resources may be lacking.

Operational advantages that may be provided by one or more embodiments of the present disclosure may include flexible, configurable resource reservation. As a consequence, for example, efficient coexistence between mMTC and another system (e.g., NR) may be achieved with minimal or decreased waste of resources and overhead. For example, time-domain resource reservation includes a first bitmap having bits representing the resource reservation in consecutive slots and the first bitmap indicates one of a slot-level resource reservation and a symbol-level resource reservation, which may provide flexibility with minimal or decreased overhead.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates an example NR and LTE-M coexistence;

FIG. 2 illustrates an example NR and NB-IoT coexistence;

FIG. 3 illustrates an example NR time-frequency resource reservation using bitmap 1 and bitmap 2;

FIG. 4 illustrates an example of valid and invalid LTE-M or NB-IoT subframes;

FIG. 5 illustrates an example of symbol-level resource reservation with a specific pattern;

FIG. 6 illustrates an example of a resource reservation with periodicity of K subframes according to some embodiments of inventive concepts;

FIG. 7 illustrates an example of multiple patterns for reserved symbols within each subframe according to some embodiments of inventive concepts;

FIG. 8 is an example illustrating indicating reserved resources (slots) according to some embodiments of inventive concepts;

FIG. 9 is an example illustrating indicating reserved symbols with four patterns according to some embodiments of inventive concepts;

FIG. 10 illustrates an example of a two-level bitmap according to some embodiments of inventive concepts;

FIG. 11 is a block diagram illustrating a mobile terminal UE according to some embodiments of inventive concepts;

FIG. 12 is a block diagram illustrating a network node (e.g., a base station eNB/gNB) according to some embodiments of inventive concepts;

FIG. 13 is a block diagram illustrating a core network node (e.g., an AMF node, an SMF node, etc.) according to some embodiments of inventive concepts;

FIG. 14 is a flow chart illustrating operations of a network node according to some embodiments of inventive concepts;

FIG. 15 is a flow chart illustrating operations of a communication device according to some embodiments of inventive concepts;

FIG. 16 is a block diagram of a communication network including an mMTC system and a NR system in accordance with some embodiments of inventive concepts;

FIG. 17 is a block diagram of a wireless network in accordance with some embodiments;

FIG. 18 is a block diagram of a user equipment in accordance with some embodiments;

FIG. 19 is a block diagram of a virtualization environment in accordance with some embodiments;

FIG. 20 is a block diagram of a telecommunication network connected via an intermediate network to a host computer in accordance with some embodiments;

FIG. 21 is a block diagram of a host computer communicating via a base station with a user equipment over a partially wireless connection in accordance with some embodiments;

FIG. 22 is a block diagram of methods implemented in a communication system including a host computer, a base station and a user equipment in accordance with some embodiments;

FIG. 23 is a block diagram of methods implemented in a communication system including a host computer, a base station and a user equipment in accordance with some embodiments;

FIG. 24 is a block diagram of methods implemented in a communication system including a host computer, a base station and a user equipment in accordance with some embodiments; and

FIG. 25 is a block diagram of methods implemented in a communication system including a host computer, a base station and a user equipment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Further discussion of inventive concepts is provided in U.S. Provisional Application No. 62/933,328, filed Nov. 8, 2019, entitled “Methods for Resource Reservation in mMTC and Related Apparatus”, which is incorporated herein by reference in its entirety.

A migration solution for LTE to NR migration, for example, that includes superior radio resource utilization efficiency and superior coexistence performance between LTE-M/NB-IoT and NR may be desirable.

In some approaches, NR resources in frequency and time domains can be configured for embedding LTE-M and NB-IoT inside an NR carrier. In frequency domain, LTE-M specific physical signals and channels may be transmitted within so called narrowbands. A narrowband may span over six Physical Resource Blocks (PRBs) where each PRB consists of 12 subcarriers. NB-IoT may include one anchor carrier with one PRB which may mainly carry system information and synchronization signals. In a multi-carrier NB-IoT deployment, in addition to the anchor carrier, there can be multiple non-anchor carriers for boosting the capacity.

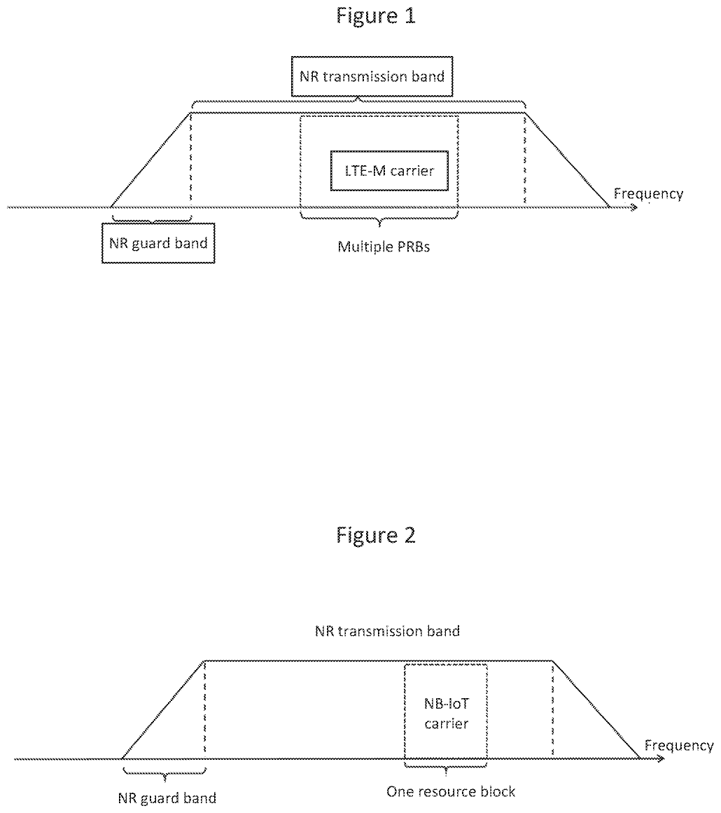

FIG. 1 illustrates an example NR and LTE-M coexistence.

FIG. 2 illustrates an example NR and NB-IoT coexistence.

For efficient coexistence between NR and LTE-M/NB-IoT, it may be important to avoid collision between NR and LTE-M/NB-IoT key transmissions and protecting specific signals/channels. For instance, the following signals/channels may need to be protected: 1) for NR: control resource set (CORESET), synchronization signal block (SSB), channel state information reference signal (CSI-RS) and tracking reference signal (TRS), 2) for LTE-M: cell-specific reference signal (CRS), primary synchronization signal (PSS), secondary synchronization signal (SSS), and 3) for NB-IoT: narrowband primary synchronization signal (NPSS), narrowband secondary synchronization signal (NSSS), narrowband reference signal (NRS), narrowband physical broadcast channel (NPBCH). Moreover, while avoiding collision between NR and LTE-M/NB-IoT transmissions, resource efficiency may need to be taken into account in the coexistence scenario.

NR resource reservation will now be described.

In NR, the concept of reserved resources was introduced to, among other benefits, facilitate forward compatibility and future radio interface extensions. These reserved resources, which are not used by NR user equipment(s) (UEs), may also be utilized to facilitate the coexistence of NR and LTE-M. As used herein, the term “not used” refers to a NR physical downlink shared channel (PDSCH) transmission is not mapped to resource elements that are reserved. As these reserved resources are known to the NR UE, the NR UE knows which resource elements are used for PDSCH and which are not, for correct PDSCH de-mapping. Approaches for resource reservation in NR may include two levels, resource block (RB) level and resource element (RE) level. On RB level, a reserved resource includes all subcarrier in an indicated resource block in frequency domain and for all or a subset of the symbols in the slot. On RE level, certain individual resource elements in an RB and slot are indicated as reserved

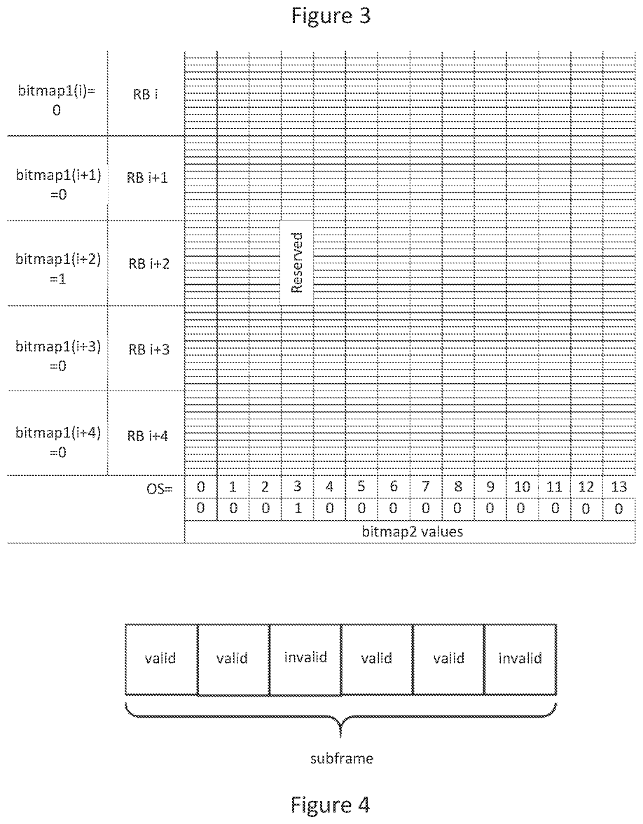

A flexible way to configure RB level resource reservation in the frequency domain may be to use a bitmap (bit stream) where each bit represents a physical resource block (PRB). In NR, bitmap 1 (PRBs in frequency domain) and bitmap 2 (symbols in time domain) are used to reserve resources in frequency and time domains, respectively. Hence, the resource reservation in NR is two dimensional. See FIG. 3 for an example of the use of bitmap 1 and 2, using PRB level resource reservation to reserve the REs of one PRB and one orthogonal frequency division multiplexing (OFDM) symbol.

NR reserved resource configuration may be needed to support LTE-M embedding on the same carrier as NR is operating, e.g., to protect LTE-M signals from NR PDSCH transmission when NR PDSCH is scheduled in the same RB as the LTE-M. To this end, in some approaches, a set of NR resources can be reserved for non-dynamically scheduled LTE-M transmissions, hence these may always need to be protected from NR PDSCH transmissions. In particular, resources may need to be reserved for at least these LTE signals, including particularly, the following LTE-M signals:
PSS (Primary Synchronization Signal), and SSS (Secondary Synchronization Signal) used by LTE/LTE-M UE for cell search procedure.
CRS (Cell-specific Reference signal) used by LTE/LTE-M UE for channel estimation, cell selection, and coherent demodulation.
PBCH (Physical Broadcast Channel) that carries system information (e.g., master information block (MIB)) for LTE/LTE-M UE requiring to access the network.
SIB1-BR (SystemInformationBlockType1) contents assist the LTE-M UE when it is evaluating cell access and also defines the scheduling of other system information.

FIG. 3 illustrates an example NR time-frequency resource reservation using bitmap 1 and bitmap 2.

Time-domain resource reservation in LTE-M and NB-IoT will now be discussed.

Referring first to valid/invalid subframes, in LTE-M and NB-IoT, the principle of resource reservation also exists, where a cell-specific subframe bitmap can be broadcasted by an evolved node B (eNB) to UEs, in order to declare valid downlink subframes for LTE-M/NB-IoT subframes. In this approach, the resource reservation is one dimensional, either a subframe is valid or invalid (also referred to as reserved) (when invalid, none of the RB is available in that subframe). In this case, the bitmap length is 10 or 40 bits are used to determine valid/invalid subframes within 1 or 4 frames (a frame is 10 subframes). Then the reservation pattern repeats itself for the following 1 or 4 frames.

For instance, an LTE-M network can indicate to an LTE-M UE, the subframes which are used for Positioning Reference Signal (PRS) or Multimedia Broadcast Multicast Service Single Frequency Network (MBSFN) transmissions as invalid subframes for LTE-M reception

FIG. 4 illustrates an example of valid and invalid LTE-M or NB-IoT subframes.

When LTE-M and NB-IoT coexist with NR as in dynamic spectrum sharing (DSS), there may be several cases where it would be beneficial if the LTE-M and NB-IoT systems avoid transmitting on resources that are desired to be used by an NR system. In some cases, it may be enough to handle this by having the LTE-M/NB-IoT and NR schedulers divide the resources on a PRB and subframe/slot/symbol level. In some cases though, it may also be useful if LTE-M and NR transmission can coexist within the same PRBs. In this regard, valid/invalid LTE-M/NB-IoT subframes may additionally be configured to protect various essential NR signals/channels. In particular, the following NR signals/channels may need to be protected:
CORESET (Control Resource Set) where NR PDCCH is located.
The synchronization signal/physical broadcast channel (SS/PBCH) block (sometimes referred to as synchronization signal block (SSB)) which includes synchronization signals (PSS and SSS), PBCH and PBCH demodulation reference signal (DM-RS).
TRS (Tracking Reference Signal) which is a channel state information reference signal (CSI-RS) resource set configured to be used for fine synchronization and channel analysis. It occupies two symbols in two adjacent subframes where the distance between the symbols in a subframe is four symbols.
CSI-RS (Channel State Information Reference Signal) to be used for CSI measurements, beam management or mobility measurements. It can be configured to start in any symbol in a subframe and can occupy 1, 2 or 4 symbols.

It should again be noted that invalid LTE-M and NB-IoT subframes configuration can be considered as subframe-level resource reservation.

Various embodiments of the present disclosure include LTE-M and NB-IoT resource reservation. Note that such reserved resources are not used for LTE-M/NB-IoT transmissions and can be dedicated to NR signals/channels. As used in the present disclosure, mMTC refers to LTE-M and NB-IoT.

In subframe-level mMTC resource reservation schemes that are included in the current version of the 3GPP standard, LTE-M/NB-IoT transmissions are not allowed anywhere in the entire invalid subframe(s). This, however, may degrade the coexistence performance in terms of resource utilization. Considering the time-domain structure of NR signals/channels, they only occupy a single or a few OFDM symbols. Thus if such subframe is reserved for NR transmission, the rest of the reserved mMTC subframe will be wasted as mMTC transmission cannot take place there.

For example, SSB spans over 4 OFDM symbols, CORESET can occupy one, two, or three symbols within an NR slot (that is, one subframe in 15 kHz SCS case). Similarly, CSI-RS and TRS can occupy only few symbols of a slot (typically one or two). Thus, subframe-level mMTC resource reservation is not efficient from resource utilization point of view.

Symbol-level and slot-level resource reservation will now be described.

To overcome the inefficiency of subframe-level resource reservation, it is currently considered in 3GPP to introduce a finer granularity for reserving mMTC resources in time domain. See, e.g., Appendix 2 (RP-191356, “Revised WID: Additional MTC enhancements for LTE”) and Appendix 3 (RP-192313, “WID revision: Additional enhancements for MB-IoT”) to U.S. Provisional Application No. 62/933,328, which is incorporated herein by reference in its entirety. In particular, slot-level and/or symbol-level resource reservation can be introduced in mMTC. Having a finer resource reservation (e.g., slot-level or symbol-level) may have two advantages: 1) it improves the resource utilization in NR and mMTC coexistence, and 2) it provides a flexibility that can facilitate the coexistence of NR URLLC services with mMTC.

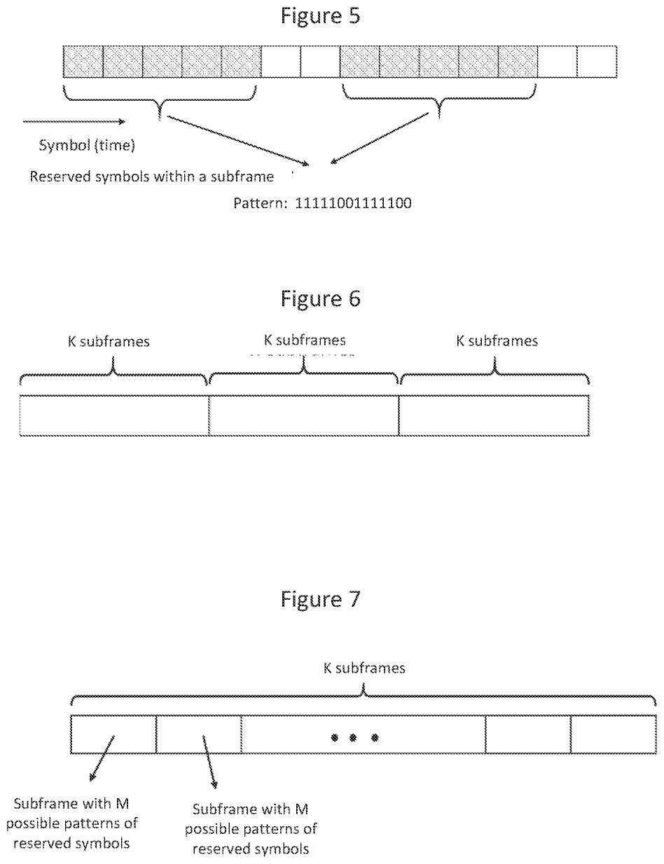

In one approach, a flexible way to indicate reserved resources in mMTC is to use a set of bitmaps. In particular, a bitmap with a specific length can point out one time period of time-domain resources (symbols, slots, or subframes) which should not be used by mMTC UEs (an illustrative example is shown in FIG. 5). In the current mMTC system, there are bitmaps of length 10 or 40 bits that can be used for indicating valid/invalid subframes in downlink and/or uplink within one or four frames. For this purpose, higher layer parameters fdd-DownlinkOrTddSubframeBitmapBR or fdd-UplinkSubframeBitmapBR can be used. Alternatively, for the downlink, the bitmap indicating the pattern of valid subframes may be given by the parameter MBSFN-SubframeConfig. As discussed, a smaller resource reservation granularity in mMTC improves the performance of NR and mMTC coexistence. For instance, within a subframe, the granularity of resource reservation can be: one symbol, multiple symbols, or one slot (that is, seven symbols).

FIG. 5 illustrates an example of symbol-level resource reservation with a specific pattern. In this example, pattern “11111001111100” indicates the reserved symbols within a given subframe (1: reserved, 0: not reserved).

Potential problems with some approaches may include the following.

Even though the slot-level and/or symbol-level resource reservation schemes that are currently studied in 3GPP help to improve the resource utilization, further optimizations or improvements may be achieved by considering resource usage of the signals in more detail. In particular, in some approaches described above, the approaches may not provide flexibility to efficiently reserve mMTC time-domain resources when coexisting with NR, considering various configurations of NR signals and channels. For example, NR SSB can be configured with different periodicities (e.g., 5, 10, 20, 40, 80, and 160 ms) and different burst sets (e.g., in FR1, up to 4 or 8 SSBs can be transmitted in different beams).

One potential limitation of some approaches described above (e.g., invalid subframes in LTE-M and NB-IoT) may be that resource reservation periodicity is limited to 10 ms or 40 ms which may not allow efficient mMTC resource reservation in coexistence scenarios. To avoid collision with NR signals/channels (e.g., SSB) in different configurations, such limitation may degrade resource utilization. Yet, another potential challenge is related to signaling aspects in order to efficiently indicate reserved resources.

A potential problem includes how to achieve an efficient resource reservation scheme to properly configure reserved resources in mMTC. Furthermore, while enhancing mMTC resource utilization, a flexible mechanism may be needed to control the overhead associated with resource reservation. In addition, tradeoff between flexibility and resource efficiency may need to be taken into account.

In various embodiments of the present disclosure, a flexible resource reservation scheme in mMTC may ensure efficient coexistence between NR and/or LTE systems and an mMTC systems with minimal or less waste of resources and overhead. Various embodiments include an optimized or improves time-domain resource reservation in mMTC to prevent or lessen collision with NR signals/channels.

FIG. 15 is a block diagram illustrating a communication network including an mMTC system and a NR system in accordance with some embodiments of inventive concepts. FIG. 15 includes a communication network 1500 in which a NR and/or LTE system coexists with a mMTC system. Network nodes 1200 (including, e.g. network nodes 1200a, 1200b, 1200c, and 1300) are included in NR and/or LTE system (represented, e.g., by 1110). Communication devices 1100 (including, e.g., communication devices 1110a, 110b, 1100c) are connected to NR and/or LTE system 1100 and a mMTC system (represented, e.g., by 1120).

Within the context of this disclosure, the term communication device a which is able to communicate with a network node, such as a base station, or with another wireless device by transmitting and/or receiving wireless signals. Thus, the term communication device encompasses, but is not limited to: a mobile phone, a stationary or mobile wireless device for machine-to-machine communication, an integrated or embedded wireless card, an externally plugged in wireless card, etc. The communication device includes any device intended for accessing services via an access network and configured to communicate over the access network. For instance, the communication device may also include, but is not limited to: a smart phone, sensor device, meter, vehicle, household appliance, medical appliance, media player, camera, or any type of consumer electronic, for instance, but not limited to, television, radio, lighting arrangement, tablet computer, laptop, or PC. The communication device may be a portable, pocket-storable, hand-held, computer-comprised, or vehicle-mounted mobile device, enabled to communicate voice and/or data, via a wireless or wireline connection. As used herein, the term communication device may be used interchangeably with user equipment (UE) or user device.

As used herein, network node refers to equipment capable, configured, arranged and/or operable to communicate directly or indirectly with a communication device and/or with other network nodes or equipment in the radio communication network to enable and/or provide wireless access to the user device and/or to perform other functions (e.g., administration) in the radio communication network. Examples of network nodes include, but are not limited to, base stations (BSs) (e.g., radio base stations, Node Bs, evolved Node Bs (eNBs), gNode Bs (including, e.g., network nodes 1200, 1300, etc.), access points (APs) (e.g., radio access points, etc. Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node. More generally, however, network nodes may represent any suitable device (or group of devices) capable, configured, arranged, and/or operable to enable and/or provide a user device with access to the telecommunications network or to provide some service to a user device that has accessed the telecommunications network.

In some embodiments, multiple resource reservation patterns in subframe-level, slot-level, and symbol-level are configured to provide flexibility. In some embodiments, overhead of resource reservation considering mMTC resource utilization in various coexistence scenarios (e.g., NR with various configurations) may addressed by including different parameters such as a resource reservation periodicity and a pattern parameter that are configurable. In various embodiments, a signaling scheme for indicating reserved resources is included.

In some embodiments, the periodicity of mMTC resource reservation is configured. The pattern of reserved resource is repeated every K subframes, with K being and integer and configurable.

In some embodiments, multiple symbol-level resource reservation patterns are defined within each subframe. In some embodiments, M different patterns are considered, with M being integer and configurable. Additionally, patterns may be determined based on the scenario.

In some embodiments, the network uses a signaling scheme for indication of reserved resources. The indication can be done using a single stream of bits and/or multiple streams of bits.

In some embodiments, the network may optimize or improve (jointly or separately) the values of K and M based on acceptable signaling overhead and flexibility to adapt with various configurations of NR signals/channels

Presently disclosed embodiments may provide potential advantages. One potential advantage may provide effective deployment of mMTC in coexistence with NR or LTE. In various embodiments, a resource reservation for NR essential signals/channels are protected while maintaining mMTC performance Additional potential advantages of various embodiments may include: 1) improving resource utilization in NR/LTE and mMTC coexistence, e g minimizing or lessening the amount of wasted (unused) resource elements, 2) allowing controlling the overhead of resource reservation, and 3) providing flexibility for reserving resources in various coexistence scenarios with different configurations.

Flexible resource reservation scheme in mMTC will now be described.

In various embodiments, periodicity of resource reservation may be included.

Existing valid/invalid subframe configuration can only have a periodicity of 10 ms or 40 ms (10 or 40 subframes) for mMTC. This periodicity limits the flexibility of the resource reservation. Flexibility may be increased with a configurable parameter K to represent resource reservation periodicity in terms of the number of subframes. K can have different integer values including 10 and 40. Meanwhile, K can also be chosen from a set of pre-defined values and indicated from, e.g., an eNB to a UE, using radio resource control (RRC) signalling.

FIG. 6 illustrates an example of a resource reservation with periodicity of K subframes according to some embodiments of the present disclosure.

In some embodiments, a periodicity of mMTC resource reservation is configured. A pattern of reserved resource is repeated every K subframes, with K being integer and configurable.

In various embodiments, patterns of resource reservation may be included.

An efficient and flexible resource reservation scheme may be provided with a resource reservation scheme where, within each subframe, various patterns can be considered for reserving symbols. In some embodiments, each subframe is associated with M possible patterns for reserved symbols. The value of M, as well as the possible patterns, can be optimized/determined based on the scenario and configurations of NR signals/channels. In some embodiments, M is the number of possible patterns. Then each subframe can adopt pattern i∈{1,2, . . . , M} for symbol-level resource reservation, with i being the index of a pattern.

FIG. 7 illustrates an example of multiple patterns for reserved symbols within each subframe according to some embodiments of the present disclosure.

In some embodiments, a suitable symbol-level pattern can also be adopted to support slot-level resource reservation. For instance: two symbol-level patterns, pattern 1: “11111110000000” and pattern 2: “00000001111111”, respectively, correspond to reserving the first slot and second slot within a subframe.

In some embodiments, multiple symbol-level resource reservation patterns are defined within each subframe. In some embodiments, M different patterns are considered, with M being integer and configurable from, e.g., an eNB to a UE. Additionally, patterns can be determined based on the scenario.

In various embodiments, indication of reserved resources may be included.

In various embodiments, there may be different ways to indicate the reserved resources. In some embodiments, a stream of bits is used to indicate which pattern is used for reserving symbols within each subframe of K subframes (resource reservation periodicity). For example, four patterns for slot-level resource reservation within 10 subframes (K=10 which is 10 ms periodicity). Ten sets of bits (total 20 bits) can be used with each set having two bits to indicate which slots are reserved within each subframe.

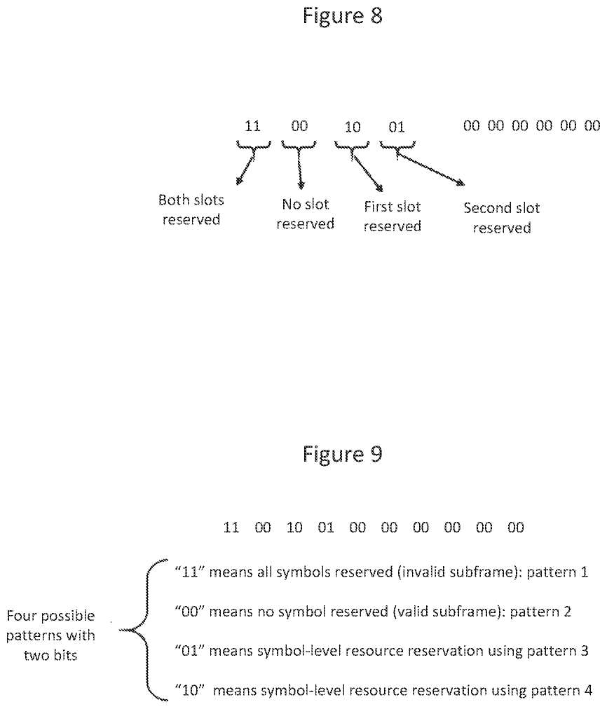

FIG. 8 is an example of indicating reserved resources (slots) according to some embodiments of the present disclosure.

In another example, ten sets of bits (total 20 bits) can be used with each set having two bits to indicate reserved symbols patterns within each subframe (as illustrated in FIG. 9).

FIG. 9 is an example of indicating reserved symbols with four patterns according to some embodiments of the present disclosure.

In some embodiments, the bitmaps depicted in FIGS. 8 and 9 have a length of 20 or 80 bits for indicating reserved resources within 10 ms and 40 ms. Each pair of bits refers to a pattern for reserved symbols or slots within each subframe. Hence, four different patterns of reserved resources within subframes can be supported. This method allows supporting slot-level resource reservation and four configurable patterns for symbol-level resource reservation.

Referring to FIG. 8, depicting an example using 10 pairs of bits, in total 20 bits, to indicate which slots are reserved within each subframe. The pair ‘11’ in FIG. 8 indicates that both slots in a subframe are reserved, thus indicating that the subframe is invalid. Similarly, the pair ‘00’ indicates that no slot in a subframe are reserved, thus indicating that the subframe is valid. The pairs ‘10’ and ‘01’ indicate the first slot or the second slot in a subframe are reserved, respectively.

Now referring to FIG. 9, also depicting an example using 10 pairs (also referred to herein as sets) of bits, in total 20 bits, with each set having two bits to indicate reserved symbols patterns within each subframe. There are four possible patterns that can be indicated with two bits representing each subframe. The pair ‘11’ in FIG. 9 indicates the pattern where all symbols in the subframe are reserved, thus indicating an invalid subframe (pattern 1 in the figure). Similarly, the pair ‘00’ indicates the pattern where no symbols in the subframe are reserved, thus indicating a valid subframe (pattern 2 in the figure). The pairs ‘01’ and ‘10’ indicate two different symbol-level resource reservation patterns, labelled pattern 3 and 4 in the figure, respectively.

Summarizing the resource reservation scheme illustrated by FIGS. 8 and 9, a bitmap for indicating reserved resources is arranged in sets of bits, each set of bits indicating one of four possible resource reservation patterns. Two sets, ‘00’ and ‘11’, correspond to the indicated valid and invalid subframes, respectively, both if slot-level resource reservation is used, as in FIG. 8, or if symbol-level resource reservation is used, as in FIG. 9. Two pairs, ‘01’ and ‘10’ correspond to partially reserved subframes, both if slot-level resource reservation or symbol-level resource reservation is used. For slot-level resource reservation, the pair ‘10’ indicates that only the first slot in the subframe is reserved, and the pair ‘01’ indicates that only the second slot in the subframe is reserved. For symbol-level resource reservation, the pair ‘01’ indicates a first symbol-level resource reservation pattern, and the pair ‘10’ indicates a second symbol-level resource reservation pattern.

In some embodiments, whether the resource reservation applies to symbol-level or slot-level resource reservation is configurable.

In some embodiments, when symbol-level resource reservation is configured, the symbol-level resource patterns associated with the partially reserved subframes are configurable.

In some embodiments, the number of bits needed for indicating M patterns of reserved symbols within each subframe with periodicity of K subframes (i.e., 10K ms) is given by:

Number of bits=┐K×┐log₂M┌

where ┐.┌ is the ceiling function for rounding to an upper integer.

In various embodiments, overhead of resource reservation can be controlled by adjusting the values of K and M. At the same time, flexibility can be provided for an efficient mMTC resource reservation.

In some embodiments, efficient use of bits is included. For example, M can be M=2ⁿ, with n being integer (i.e., M=2, 4, 8, etc.,).

In some embodiments, the network optimizes or increases (jointly or separately) the values of K and M based on acceptable overhead and flexibility to adapt with various configurations of NR signals/channels.

In some embodiments, the number of patterns for reserved symbols is M=2ⁿ, with n being integer (i.e., M=2, 4, 8, etc.,).

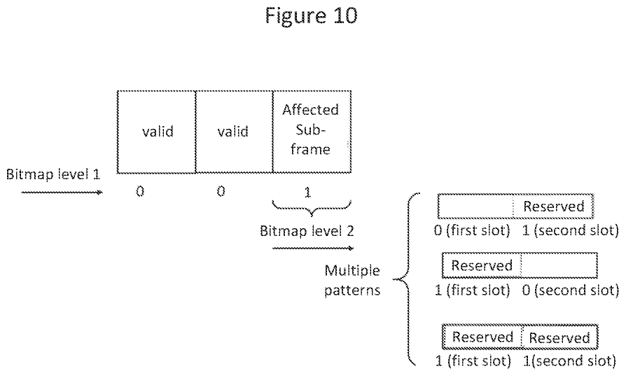

Reserve resources may be indicated by using a two-level bitmap. See e.g., Appendix 1 to U.S. Provisional Application No. 62/933,328, filed Nov. 8, 2019, entitled “Methods for Resource Reservation in mMTC and Related Apparatus” (Appendix 1, U.S. Provisional patent application entitled “Long-Term Evolution-M Resource Reservation Using Bitmap”), which is incorporated herein by reference in its entirety. In some embodiments, a two-level bitmap (bitmap 1 and bitmap 2) is used in which the first bitmap indicates the subframes and the second bitmap indicates the patterns for the reserved symbols within those subframes identified by the first bitmap. Bitmap 2 does not need to be applied to fully available subframes. That is, bitmap 2 refers to subframes which are fully or partially reserved (these subframes are also referred to herein as “affected subframes”), as illustrated in FIG. 10 according to some embodiments of the present disclosure.

In some embodiments, L is a number of subframes which are fully or partially reserved, and is L≤K. In some embodiments, the number of bits needed for indicating M patterns of reserved symbols within each affected subframe with periodicity of K subframes (i.e., 10K ms) is given by:

Number of bits=K+(L×┐log₂M┌).

In some embodiments, the indication for patterns of reserved symbols is only applied to affected subframes.

Referring again to the examples in FIG. 8 and FIG. 9, it can be observed that there are several consecutive indications “00”, indicating no slots/symbols reserved. In cases where the reserved resources come in bursts with long periods of unreserved resources in between, there may be more efficient ways of representing these unreserved resources than with a bitmap. Thus, the 20 bit sequence “11 00 10 01 00 00 00 00 00 00” may instead be represented by the 8 bit sequence “11 00 10 01” corresponding to 4 subframes with varying reservation patterns, followed by 6 unreserved subframes. Since the number 6 can be represented by three binary bits, the complete pattern would be possibly to represent by using in total 8+3=11 bits instead of 20 in this particular example.

More generally, in some embodiments, the indication of the reservation pattern can be made using a bitmap pattern as indicated above, in combination with a leading number of unreserved subframes and a trailing number of unreserved subframes. In another embodiment, a total length of the combined reservation pattern is represented by a periodicity. The leading number of unreserved subframes may then equivalently be considered an offset for when to apply the bitmap pattern.

In another embodiment, e.g. when most resources are reserved, the leading and trailing number of subframes represent reserved resources. In another embodiment, an additional bit is used to indicate whether the leading subframes represent reserved or unreserved resources, and similarly for the trailing bits.

The embodiments above can be combined in several different ways. As non-limiting examples, the combinations may be used to represent longer patterns of resource reservations by having also one or more sequences of intermediate reserved/reserved subframes, resource reservation of different granularities, and resource reservation using different numbers of M possible patterns. For example, in a case where only one pattern of reserved resources has been defined, in which case this can be represented by only one bit per subframe for the bitmap, together with the leading and trailing subframes.

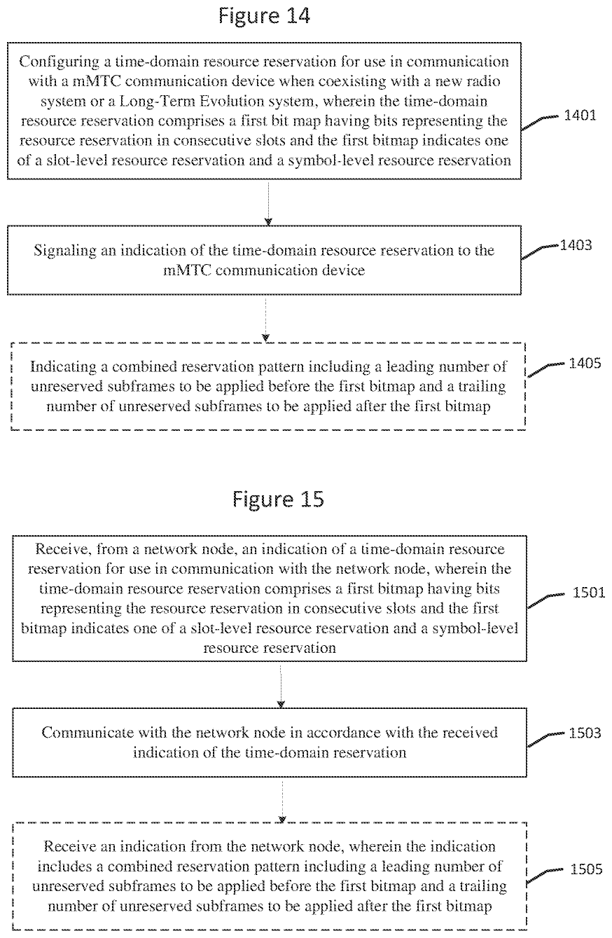

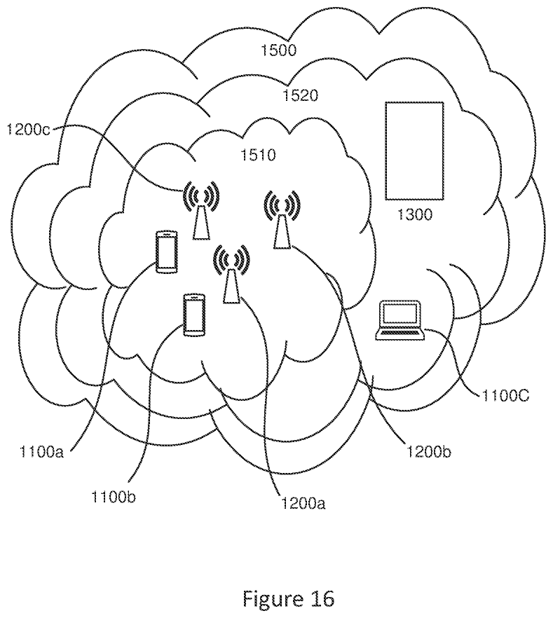

These and other related operations will now be described in the context of the operational flowchart of FIGS. 14 and 15 of operations that may be performed by a network node (e.g., network node 1200) and a communication device (e.g., communication device 1100) according to various embodiments of inventive concepts. Each of the operations described in FIGS. 14 and 15 can be combined and/or omitted in any combination with each other, and it is contemplated that all such combinations fall within the spirit and scope of this disclosure.

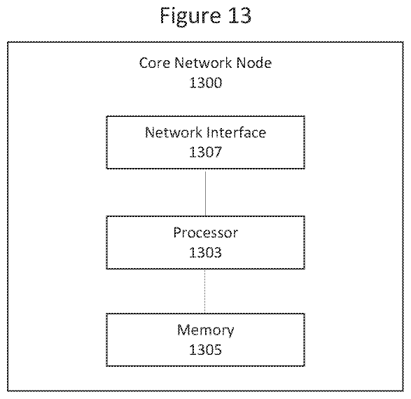

Referring to FIG. 14, operations can be performed by a network node (e.g., 1200 implemented using the structure of the block diagram of FIG. 12 or 1300 implemented using the structure of the block diagram of FIG. 13). The operations of network node 1200, 1300 include configuring (1401) a time-domain resource reservation for use in communication with a massive machine-type communication, mMTC, communication device when coexisting with a new radio system or a Long-Term Evolution system. The time-domain resource reservation includes a first bitmap having bits representing the resource reservation in consecutive slots and the first bitmap indicates one of a slot-level resource reservation and a symbol-level resource reservation. The operations further include signaling (1403) an indication of the time-domain resource reservation to the mMTC communication device.

In some embodiments, the bits in the first bitmap are arranged in pairs of two-bit patterns, and wherein the two-bit pattern in each pair of bits corresponds to a first slot and a second slot in a single subframe.

In some embodiments, the two-bit pattern of a pair is an indication that resources in the first slot and the second slot in the pair are either both reserved or both unreserved, and the indication applies to all symbols in the first slot and the second slot regardless of whether the first bitmap pertains to the slot-level resource reservation or the symbol-level resource reservation.

In some embodiments, the first bitmap is a slot-level resource reservation having the two-bit pattern of a pair that is an indication that resources in only the first slot or the second slot in the pair are reserved, and wherein the indication applies to all symbols in the first slot or the second slot in the pair, respectively.

In some embodiments, the first bitmap includes a two-level bitmap and includes a symbol-level resource reservation. Ehen the two-bit pattern of a pair in the first bitmap is a first indication that resources in only the first slot in the pair are reserved, the first indication applies to symbols given by a second bitmap of the two-level bitmap, or when the two-bit pattern of a pair in the first bitmap is a second indication that resources in only the second slot in the pair are reserved, the second indication applies to symbols given by a third bitmap of the two-level bitmap.

In some embodiments, the signaling (1403) includes indicating whether the first bitmap is for the symbol-level resource reservation or the slot-level resource reservation.

In some embodiments, when a time-domain resource is indicated as a reserved resource, the time-domain resource is not available to use for communication with the mMTC communication device.

In some embodiments, communication with the mMTC communication device takes can take place in the time-domain resources indicated as not being reserved.

In some embodiments, the first bitmap includes a length of 20 bits or 80 bits, the 20 bits or 80 bits indicating reserved resources within 10 ms or 40 ms, respectively.

In some embodiments, the length of the first bitmap is configurable.

In some embodiments, the method further includes indicating (1405) a combined reservation pattern including a leading number of unreserved subframes to be applied before the first bitmap and a trailing number of unreserved subframes to be applied after the first bitmap.

In some embodiments, the leading number of subframes corresponds to an offset for when to apply the pattern indicated by the first bitmap, and the total length of the combined reservation pattern is represented by a periodicity.

In some embodiments, the configuring (1401) a time-domain resource reservation further includes configuring a resource reservation periodicity of the time-domain resource reservation.

In some embodiments, the resource reservation periodicity includes units of the number of subframes.

In some embodiments, the configuring a time-domain resource reservation includes configuring a resource reservation pattern in one of one or more subframes, one or more slots of the one or more subframes, and/or one or more symbol levels.

In some embodiments, the configuring a time-domain resource reservation further includes configuring a resource reservation periodicity of the time-domain resource reservation.

In some embodiments, the configuring a resource reservation periodicity of the time-domain resource includes configuring a parameter, K, to represent the resource reservation periodicity in units of a number of subframes.

In some embodiments, the parameter, K, has an integer value, and the signaling an indication of the resource reservation to a communication device includes using radio resource control signaling to indicate to the communication device a set of pre-defined integer values for the parameter, K, from which the parameter, K, is configured.

In some embodiments, the resource reservation pattern is repeated at the periodicity in units of the number of subframes.

In some embodiments, each of the one or more subframes includes one or more patterns for reserved symbols; the one or more patterns for reserved symbols is defined by a value, M and the value, M, is an integer; and the value, M, is configurable from the network node to the communication device.

In some embodiments, the signaling an indication of the resource reservation to a communication device includes a stream of bits indicating which of the patterns from the one or more patterns for reserved symbols defined by the value, M, is used for reserved symbols within the one or more subframes of each resource reservation periodicity.

In some embodiments, the number of bits for indicating M patterns of reserved symbols within each of the one or more subframes of each resource reservation periodicity is as follows:

Number of bits=K×┐log₂M┌

where ┐.┌ is a ceiling function.

In some embodiments, M=2n, where n is an integer.

In some embodiments, K and/or N are configured based on defined overhead and defined flexibility to adapt to various configurations of new radio signals and/or channels.

In some embodiments, the signaling an indication of the resource reservation to a communication device includes a two-level bitmap.

In some embodiments, the two-level bitmap comprises a first bitmap indicating the number of the one or more subframes and a second bitmap indicating the patterns for reserved symbols within each of the one or more subframes that is fully or partially reserved that is identified in the first bitmap.

In some embodiments, the each of the one or more subframes that is fully or partially reserved has a number, L, that is less than or equal to K, and the number of bits for indicating M patterns of reserved symbols within the each of the one or more subframes that is fully or partially reserved with the resource reservation periodicity, K, is as follows:

Number of bits=K(L×┐log₂M┌).

In some embodiments, the indicating the patterns for reserved symbols within each of the one or more subframes that is fully or partially reserved is only applied to the fully or partially reserved subframes.

In some embodiments, the indicating the patterns for reserved symbols within each of the one or more subframes that is fully or partially reserved made using the second bitmap further includes a leading number of unreserved subframes and a trailing number of unreserved subframes to provide a combined reservation pattern.

In some embodiments, the combined reservation pattern is represented by the resource reservation periodicity.

In some embodiments, the indicating the patterns for reserved symbols within each of the one or more subframes that is fully or partially reserved made using the second bitmap further comprises a leading number of reserved subframes and a trailing number of reserved.

In some embodiments, the indicating the patterns for reserved symbols within each of the one or more subframes that is fully or partially reserved made using the second bitmap further comprises an additional leading bit indicating whether the leading subframes represent reserved or unreserved resources and an additional trailing bit indicating whether the trailing subframes represent reserved or unreserved resources.

According to some embodiments, a network node (e.g., 1200, 1300) of a communications network (e.g., 1500) is provided. The network node can include at least one processor (e.g., 1203, 1303). The network node also can include a memory (e.g., 1205, 1305). The memory can contain instructions executable by the at least one processor. The network node is operative to configure a time-domain resource reservation in massive machine-type communication, mMTC, when coexisting with a new radio system or a Long Term Evolution system. The time-domain resource reservation includes a first bitmap having bits representing the resource reservation in consecutive slots and the first bitmap indicates one of a slot-level resource reservation and a symbol-level resource reservation. The network node is further operative to signal an indication of the resource reservation to a communication device.

According to some embodiments, a computer program can be provided that includes instructions which, when executed on at least one processor (1203, 1303), cause the at least one processor to carry out methods performed by the network node (1200, 1300).

According to some embodiments, a computer program product can be provided that includes a non-transitory computer readable medium (1205, 1305)) including program code to be executed by processing circuitry (1203, 1303) of a network node (1200, 1300) that, when execution of the program code causes the network node to carry out methods performed by the network node.

In some embodiments, the first bitmap includes bits representing the resource reservation in two consecutive slots of a subframe, and the resource reservation represented in the first bitmap indicates one of the slot-level resource reservation and the symbol-level resource reservation.

In some embodiments, the bits in the first bitmap are arranged in pairs of two-bit patterns, and the two-bit pattern in each pair of bits corresponds to a first slot and a second slot in a single subframe.

In some embodiments, the two-bit pattern of a pair is an indication that resources in the first slot and the second slot in the pair are either both reserved or both unreserved, and the indication applies to all symbols in the first slot and the second slot regardless of whether the first bitmap pertains to the slot-level resource reservation or the symbol-level resource reservation.

In some embodiments, the first bitmap is a slot-level resource reservation having the two-bit pattern of a pair that is an indication that resources in only the first slot or the second slot in the pair are reserved, and the indication applies to all symbols in the first slot or the second slot in the pair, respectively.

In some embodiments, the first bitmap includes a two-level bitmap and comprises a symbol-level resource reservation, and when the two-bit pattern of a pair in the first bitmap is a first indication that resources in only the first slot in the pair are reserved, the first indication applies to symbols given by a second bitmap of the two-level bitmap, or when the two-bit pattern of a pair in the first bitmap is a second indication that resources in only the second slot in the pair are reserved, the second indication applies to symbols given by a third bitmap of the two-level bitmap.

In some embodiments, the signaling (1403) includes indicating whether the first bitmap is for the symbol-level resource reservation or the slot-level resource reservation.

In some embodiments, when a time-domain resource is indicated as a reserved resource, the time-domain resource is not available to use for communication with the mMTC communication device.

In some embodiments, communication with the mMTC communication device takes can take place in the time-domain resources indicated as not being reserved.

In some embodiments, the first bitmap includes a length of 20 bits or 80 bits, the 20 bits or 80 bits indicating reserved resources within 10 ms or 40 ms, respectively.

In some embodiments, the length of the first bitmap is configurable.

In some embodiments, the method further includes indicating (1405) a combined reservation pattern including a leading number of unreserved subframes to be applied before the first bitmap and a trailing number of unreserved subframes to be applied after the first bitmap.

In some embodiments, the leading number of subframes corresponds to an offset for when to apply the pattern indicated by the first bitmap, and the total length of the combined reservation pattern is represented by a periodicity.

In some embodiments, wherein the configuring (1401) a time-domain resource reservation further includes configuring a resource reservation periodicity of the time-domain resource reservation.

In some embodiments, the resource reservation periodicity includes units of the number of subframes.

Various operations from the flow charts of FIG. 14 may be optional with respect to some embodiments of network nodes and related methods. For example, operations of block 1405 of FIG. 14 may be optional.

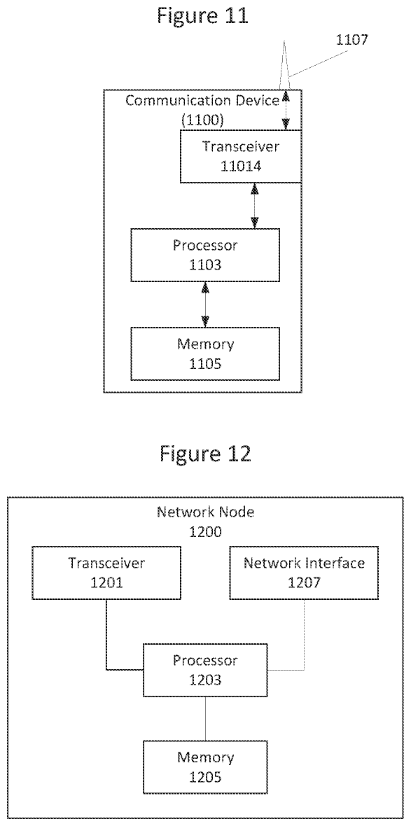

Referring to FIG. 15, operations can be performed by a mMTC communication de (e.g., 1100 implemented using the structure of the block diagram of FIG. 11). The operations of communication device 1100 include receiving (1501), from a network node, an indication of a time-domain resource reservation for use in communication with the network node. The time-domain resource reservation includes a first bitmap having bits representing the resource reservation in consecutive slots and the first bitmap indicates one of a slot-level resource reservation and a symbol-level resource reservation. The method further includes communicating (1503) with the network node in accordance with the received indication of the time-domain reservation. In some embodiments, the bits in the first bitmap are arranged in pairs of two-bit patterns, and the two-bit pattern in each pair of bits corresponds to a first slot and a second slot in a single subframe.

In some embodiments, the two-bit pattern of a pair is an indication that resources in the first slot and the second slot in the pair are either both reserved or both unreserved, and the indication applies to all symbols in the first slot and the second slot regardless of whether the first bitmap pertains to the slot-level resource reservation or the symbol-level resource reservation.

In some embodiments, the first bitmap is a slot-level resource reservation having the two-bit pattern of a pair that is an indication that resources in only the first slot or the second slot in the pair are reserved, and the indication applies to all symbols in the first slot or the second slot in the pair, respectively.

In some embodiments, the first bitmap includes a two-level bitmap and comprises a symbol-level resource reservation. When the two-bit pattern of a pair in the first bitmap is a first indication that resources in only the first slot in the pair are reserved, the first indication applies to symbols given by a second bitmap of the two-level bitmap; or when the two-bit pattern of a pair in the first bitmap is a second indication that resources in only the second slot in the pair are reserved, the second indication applies to symbols given by a third bitmap of the two-level bitmap.

In some embodiments, when a time-domain resource is indicated as a reserved resource, the time-domain resource is not available to use for communication with the network node.

In some embodiments, communication with the network node can take place in the time-domain resources indicated as not being reserved.

In some embodiments, the first bitmap includes a length of 20 bits or 80 bits, the 20 bits or 80 bits indicating reserved resources within 10 ms or 40 ms, respectively.

In some embodiments, the length of the first bitmap is configurable by the network node.

In some embodiments, the method further includes receiving (1505) an indication from the network node. The indication includes a combined reservation pattern including a leading number of unreserved subframes to be applied before the first bitmap and a trailing number of unreserved subframes to be applied after the first bitmap.

In some embodiments, the leading number of subframes corresponds to an offset for when to apply the pattern indicated by the first bitmap, and the total length of the combined reservation pattern is represented by a periodicity.

In some embodiments, the a time-domain resource reservation further includes a configuration of a resource reservation periodicity of the time-domain resource reservation.

In some embodiments, the resource reservation periodicity includes units of the number of subframes.

In some embodiments, the mMTC communication device is one of an LTE-M device and an NB-IoT device.

According to some embodiments, a massive machine-type communication, mMTC, communication device (1100) is provided. The communication device includes processing circuitry (1103). The communication device further includes memory (1105) coupled with the processing circuitry. The memory includes instructions that when executed by the processing circuitry causes the mMTC communication device to perform operations including receive, from a network node, an indication of a time-domain resource reservation for use in communication with the network node, wherein the time-domain resource reservation comprises a first bitmap having bits representing the resource reservation in consecutive slots and the first bitmap indicates one of a slot-level resource reservation and a symbol-level resource reservation. The communication device is further operative to communicate with the network node in accordance with the received indication of the time-domain reservation.

According to some embodiments, a computer program can be provided that includes instructions which, when executed on processing circuitry (1103), cause the processing circuitry to carry out methods performed by the mMTC communication device (1100).

According to some embodiments, a computer program product can be provided that includes a non-transitory computer readable medium (1105) including program code to be executed by processing circuitry (1103) of a mMTC communication device (1100) that, when execution of the program code causes the mMTC communication device to carry out methods performed by the mMTC communication device.

Various operations from the flow charts of FIG. 15 may be optional with respect to some embodiments of mMTC communication devices and related methods. For example, operations of block 1505 of FIG. 15 may be optional.

FIG. 11 is a block diagram illustrating a communication device 1100 that is configured according to some embodiments. The communication device 1100 can include, without limitation, a wireless communication device, a wireless terminal, a wireless communication terminal, a terminal node/UE/device, etc. The communication device 1100 includes a transceiver 1101 comprising one or more power amplifiers the transmit and receive through antennas of an antenna array 1107 to provide uplink and downlink radio communications with a radio network node (e.g., a base station, eNB, gNB, etc.) of a telecommunications network. Communications device 1100 further includes a processor circuit 1103 (also referred to as at least one processor) coupled to the transceiver 1101 and a memory circuit 1105 (also referred to as memory). The memory 1105 stores computer readable program code that when executed by the processor circuit 1103 causes the processor circuit 1103 to perform operations according to embodiments disclosed herein.

FIG. 12 is a block diagram illustrating a network node 1200 (e.g., a base station, eNB, gNB, etc.) of a telecommunications network. Communication device 1100 also may include a wired connection to, e.g., a network node or another communication device via a network interface (not shown). The network node 1200 includes a processor circuit 1203 (also referred to as at least one processor), a memory circuit 1205 (also referred to as memory), and a network interface 1207 (e.g., wired network interface and/or wireless network interface) configured to communicate with other network nodes. The network node 1200 may be configured as a radio network node containing a transceiver 1201 with one or more power amplifiers that transmit and receive through antennas of an antenna array (not shown). The memory 1205 stores computer readable program code that when executed by the processor circuit 1203 causes the processor circuit 1203 to perform operations according to embodiments disclosed herein.

According to some other embodiments, a network node may be implemented as a core network node without a transceiver. In such embodiments, transmission to a communication device may be initiated by the network node so that transmission to the communication device is provided through a network node including a transceiver (e.g., through a base station or radio access network (RAN)) node). According to embodiments where the network node is a RAN node including a transceiver, initiating transmission may include transmitting through the transceiver.

FIG. 13 is a block diagram illustrating elements of a core network node of a communication network configured to provide communication according to embodiments of inventive concepts. As shown, the core network node may include network interface circuitry 1307 (also referred to as a network interface) configured to provide communications with other nodes of the core network and/or network nodes and/or communication devices. The core network node may also include a processing circuitry 1303 (also referred to as at least one processor) coupled to the network interface circuitry, and memory circuitry 1305 (also referred to as memory) coupled to the processing circuitry. The memory circuitry 1305 may include computer readable program code that when executed by the processing circuitry 13503 causes the processing circuitry to perform operations according to embodiments disclosed herein. According to other embodiments, processing circuitry 1303 may be defined to include memory so that a separate memory circuitry is not required.

As discussed herein, operations of the core network node may be performed by processing circuitry 1303 and/or network interface circuitry 1307. For example, processing circuitry 1303 may control network interface circuitry 1307 to transmit communications through network interface circuitry 1307 to one or more other network nodes and/or to receive communications through network interface circuitry from one or more other network nodes or communication devices. Moreover, modules may be stored in memory 1305, and these modules may provide instructions so that when instructions of a module are executed by processing circuitry 1303, processing circuitry 1303 performs respective operations (e.g., operations discussed below with respect to Example Embodiments relating to network nodes).

Aspects of the present disclosure have been described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Example embodiments are provided below. Reference numbers/letters are provided in parenthesis by way of example/illustration without limiting example embodiments to particular elements indicated by reference numbers/letters.

### Listing of Embodiments

Embodiment 1. A method of operating a network node (1200, 1300) in a communication network (1500), the method includes configuring (1401) a time-domain resource reservation in massive machine-type communication, mMTC, when coexisting with a new radio system or a Long-Term Evolution system. The method further includes signaling (1403) an indication of the resource reservation to a communication device.

Embodiment 2. The method of Embodiment 1, wherein the configuring a time-domain resource reservation includes configuring a resource reservation pattern in one of one or more subframes, one or more slots of the one or more subframes, and/or one or more symbol levels.

Embodiment 3. The method of any of Embodiments 1 to 2, wherein the configuring a time-domain resource reservation further includes configuring a resource reservation periodicity of the time-domain resource reservation.

Embodiment 4. The method of Embodiment 3, wherein the configuring a resource reservation periodicity of the time-domain resource includes configuring a parameter, K, to represent the resource reservation periodicity in units of a number of subframes.

Embodiment 5. The method of Embodiment 4, wherein the parameter, K, has an integer value, and wherein the signaling an indication of the resource reservation to a communication device comprises using radio resource control signaling to indicate to the communication device a set of pre-defined integer values for the parameter, K, from which the parameter, K, is configured.

Embodiment 6. The method of any of Embodiments 2 to 5, wherein the resource reservation pattern is repeated at the periodicity in units of the number of subframes.

Embodiment 7. The method of any of Embodiments 2 to 7, wherein each of the one or more subframes includes one or more patterns for reserved symbols, wherein the one or more patterns for reserved symbols is defined by a value, M and the value, M, is an integer; and wherein the value, M, is configurable from the network node to the communication device.

Embodiment 8. The method of any of Embodiments 1 to 7, wherein the signaling an indication of the resource reservation to a communication device includes a stream of bits indicating which of the patterns from the one or more patterns for reserved symbols defined by the value, M, is used for reserved symbols within the one or more subframes of each resource reservation periodicity.

Embodiment 9. The method of Embodiments 8, wherein the number of bits for indicating M patterns of reserved symbols within each of the one or more subframes of each resource reservation periodicity is as follows: Number of bits=K×┐log₂M┌, where ┐.┌ is a ceiling function.

Embodiment 10. The method of any of Embodiments 7 to 9, wherein M=2′, where n is an integer.

Embodiment 11. The method of any of Embodiments, 4 to 10, wherein K and/or N are configured based on defined overhead and defined flexibility to adapt to various configurations of new radio signals and/or channels.

Embodiment 12. The method of any of Embodiments 1 to 7, wherein the signaling an indication of the resource reservation to a communication device includes a two-level bitmap.

Embodiment 13. The method of Embodiment 12, wherein the two-level bitmap includes a first bitmap indicating the number of the one or more subframes and a second bitmap indicating the patterns for reserved symbols within each of the one or more subframes that is fully or partially reserved that is identified in the first bitmap.

Embodiment 14. The method of Embodiment 13, wherein the each of the one or more subframes that is fully or partially reserved has a number, L, that is less than or equal to K, and the number of bits for indicating M patterns of reserved symbols within the each of the one or more subframes that is fully or partially reserved with the resource reservation periodicity, K, is as follows: Number of bits=K (L×┐log₂M┌).

Embodiment 15. The method of any of Embodiments 13 to 14, wherein the indicating the patterns for reserved symbols within each of the one or more subframes that is fully or partially reserved is only applied to the fully or partially reserved subframes.

Embodiment 16. The method of any of Embodiments 13 to 15, wherein the indicating the patterns for reserved symbols within each of the one or more subframes that is fully or partially reserved made using the second bitmap further includes a leading number of unreserved subframes and a trailing number of unreserved subframes to provide a combined reservation pattern.

Embodiment 17. The method of Embodiment 16, wherein the combined reservation pattern is represented by the resource reservation periodicity.

Embodiment 18. The method of any of Embodiments 13 to 15, wherein the indicating the patterns for reserved symbols within each of the one or more subframes that is fully or partially reserved made using the second bitmap further includes a leading number of reserved subframes and a trailing number of reserved.

Embodiment 19. The method of any of Embodiments 13 to 15, wherein the indicating the patterns for reserved symbols within each of the one or more subframes that is fully or partially reserved made using the second bitmap further includes an additional leading bit indicating whether the leading subframes represent reserved or unreserved resources and an additional trailing bit indicating whether the trailing subframes represent reserved or unreserved resources.

Embodiment 20. A network node (1200, 1300) including processing circuitry (1203, 1303); and memory (1205, 1305) coupled with the processing circuitry. The memory includes instructions that when executed by the processing circuitry causes the network node to perform operations including configure a time-domain resource reservation in massive machine-type communication, mMTC, when coexisting with a new radio system or a Long Term Evolution system. The operations further include signal an indication of the resource reservation to a communication device.

Embodiment 21. The network node of claim 20, wherein the memory includes instructions that when executed by the processing circuitry causes the network node to perform further operations according to any of Embodiments 2-19.

Embodiment 22. A computer program including program code to be executed by processing circuitry (1203, 1303) of a network node (1200, 1300), whereby execution of the program code causes the network node to perform operations according to any of embodiments 1-19.

Embodiment 23. A computer program product including a non-transitory storage medium (1205, 1305) including program code to be executed by processing circuitry (1203, 1303) of a network node, whereby execution of the program code causes the network node to perform operations according to any of embodiments 1-19.

Explanations are provided below for various abbreviations/acronyms used in the present disclosure.

### Abbreviation Explanation

3GPP 3rd Generation Partnership Project
CORESET Control Resource Set
CRS Cell-specific Reference Signal
CSI-RS Channel State Information Reference Signal
DL Downlink
DMRS Demodulation Reference Signal
eNB Evolved Node B
IoT Internet of Things
LTE Long-Term Evolution
LTE-M Long-Term Evolution for Machine-Type Communications
LTE-MTC Long-Term Evolution for Machine-Type Communications
MBSFN Multicast Service Single Frequency Network
NB-IoT Narrowband Internet-of-Things
mMTC Massive Machine-type Communication
NR New Radio
NRS Narrowband Reference Signal
NS SS Narrowband Secondary Synchronization Signal
PBCH Physical Broadcast Channel
PRB Physical Resource Block
PSS Primary Synchronization Signal
RE Resource Element
RRC Radio Resource Control
SSB Synchronization Signal Block
SSS Secondary Synchronization Signal
TDD Time Division Duplex
TRS Tracking Reference Signal
UE User Equipment
UL Uplink

References are identified below.
[1] RP-191356, “Revised WID: Additional MTC enhancements for LTE”. (Appendix 2 to U.S. Provisional Application No. 62/933,328, filed Nov. 8, 2019, entitled “Methods for Resource Reservation in mMTC and Related Apparatus”, which is incorporated herein by reference in its entirety).
[2] RP-192313, “WID revision: Additional enhancements for NB-IoT”. (Appendix 3 to U.S. Provisional Application No. 62/933,328, filed Nov. 8, 2019, entitled “Methods for Resource Reservation in mMTC and Related Apparatus”, which is incorporated herein by reference in its entirety).
[3] P78755, “LTE-M resource reservation using bitmap”. (Appendix 1 to U.S. Provisional Application No. 62/933,328, filed Nov. 8, 2019, entitled “Methods for Resource Reservation in mMTC and Related Apparatus”, which is incorporated herein by reference in its entirety).

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

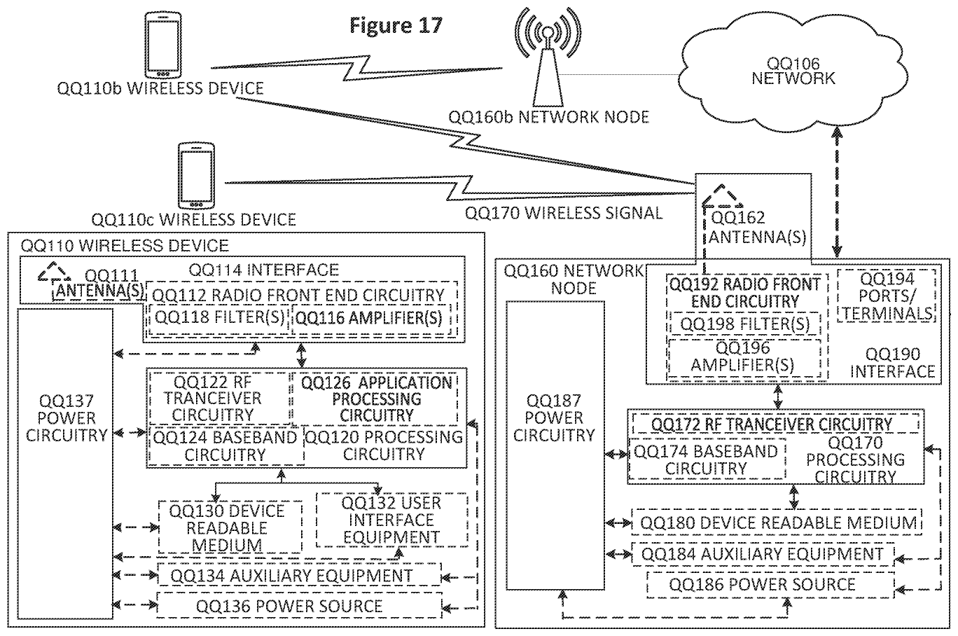

FIG. 17 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 17. For simplicity, the wireless network of FIG. 17 only depicts network QQ106, network nodes QQ160 and QQ160b, and WDs QQ110, QQ110b, and QQ110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 17, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 171 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 17 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

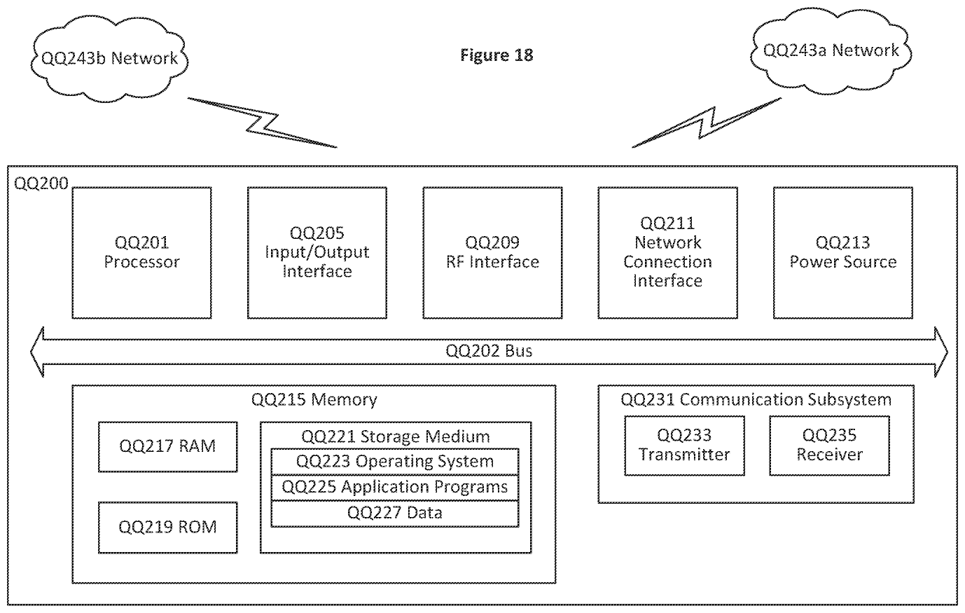

FIG. 18 illustrates a user Equipment in accordance with some embodiments.

FIG. 18 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3rd Generation Partnership Project (3GPP), including a NB-IoT UE, a machine type communication (MTC) UE, and/or an enhanced MTC (eMTC) UE. UE QQ200, as illustrated in FIG. 18, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 18 is a UE, the components discussed herein are equally applicable to a WD, and vice-versa.

In FIG. 18, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 18, or only a subset of the components. The level of integration between the components may vary from one UE to another UE. Further, certain UEs may contain multiple instances of a component, such as multiple processors, memories, transceivers, transmitters, receivers, etc.

In FIG. 18, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 18, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. 18, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

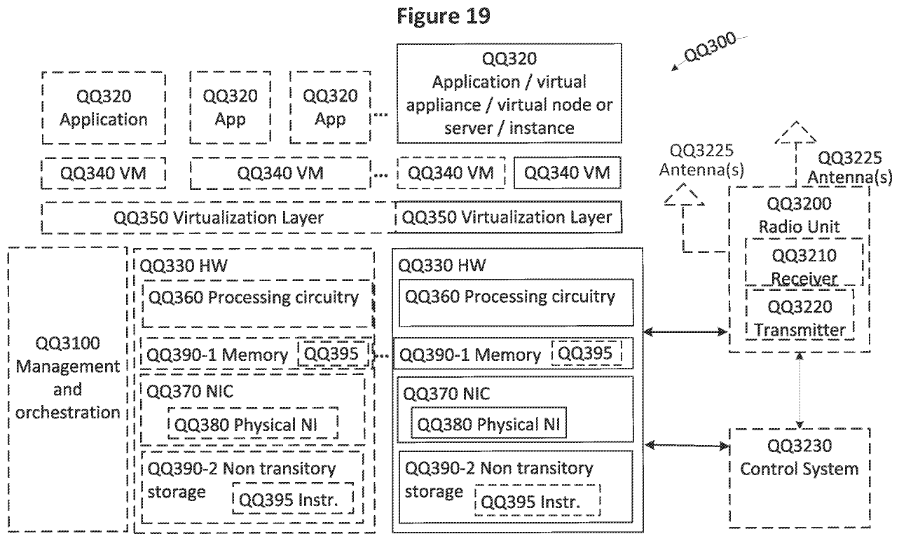

FIG. 19 illustrates a virtualization environment in accordance with some embodiments.

FIG. 19 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 19, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 19.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

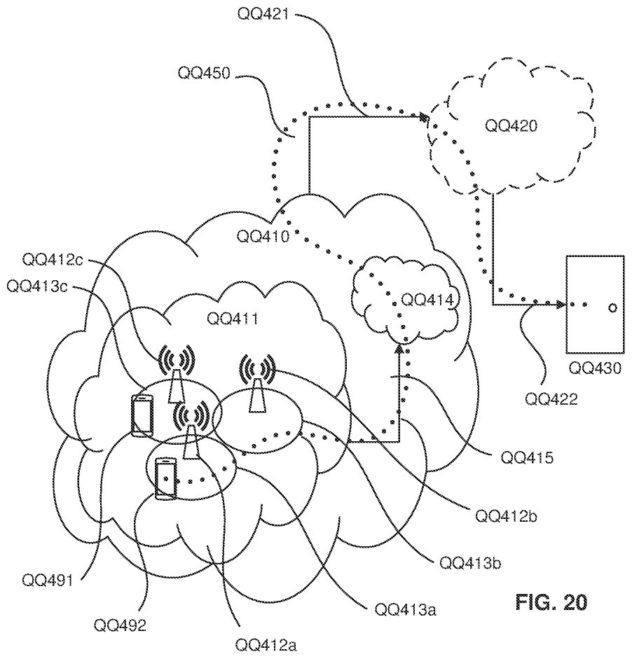

FIG. 20 illustrates a telecommunication network connected via an intermediate network to a host computer in accordance with some embodiments.

With reference to Figure QQ4, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 20 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

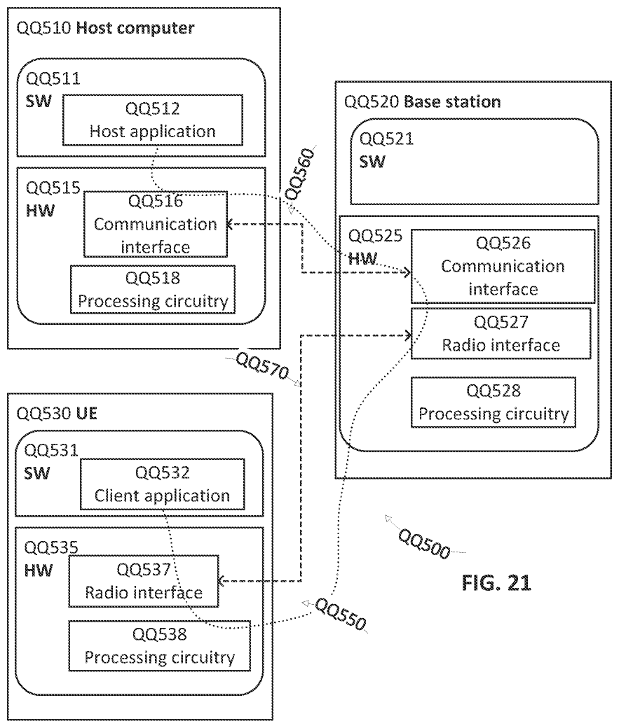

FIG. 21 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 21. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 21) served by base station QQ520. Communication interface QQ526 may be configured to facilitate connection QQ560 to host computer QQ510. Connection QQ560 may be direct or it may pass through a core network (not shown in FIG. 21) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 21 may be similar or identical to host computer QQ430, one of base stations QQ412a, QQ412b, QQ412c and one of UEs QQ491, QQ492 of FIG. 20, respectively. This is to say, the inner workings of these entities may be as shown in FIG. 21 and independently, the surrounding network topology may be that of FIG. 20.

In FIG. 21, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments may improve the performance of OTT services provided to UE QQ530 using OTT connection QQ550, in which wireless connection QQ570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

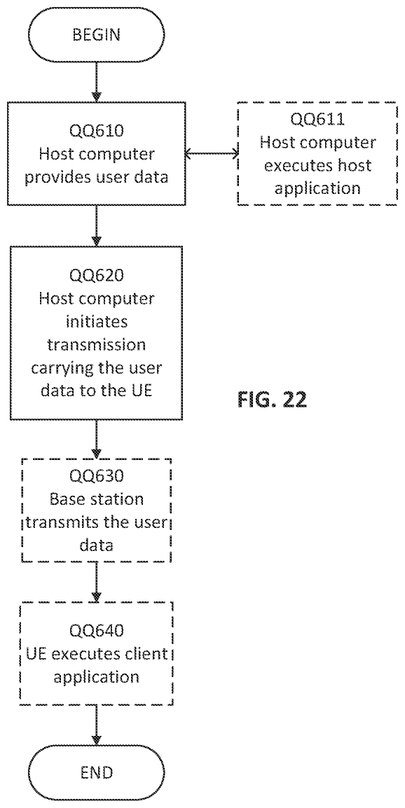

FIG. 22 illustrates methods implemented in a communication system including a host computer, a base station and a user equipment in accordance with some embodiments

FIG. 22 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 22 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

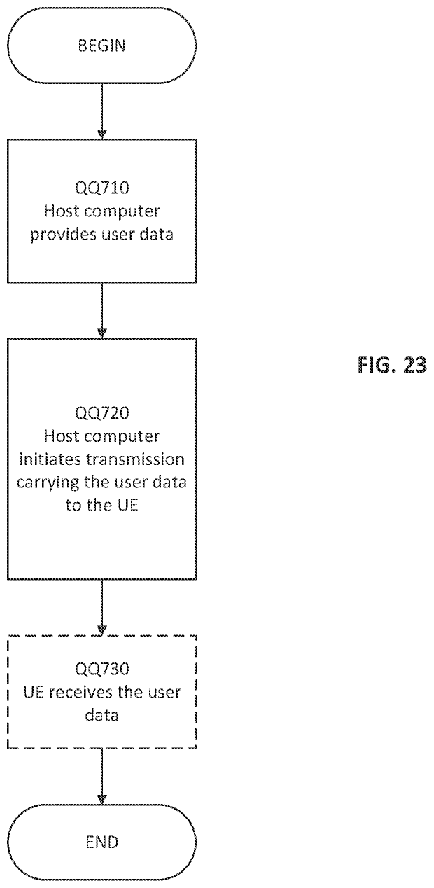

FIG. 23 illustrates methods implemented in a communication system including a host computer, a base station and a user equipment in accordance with some embodiments.

FIG. 23 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 23 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

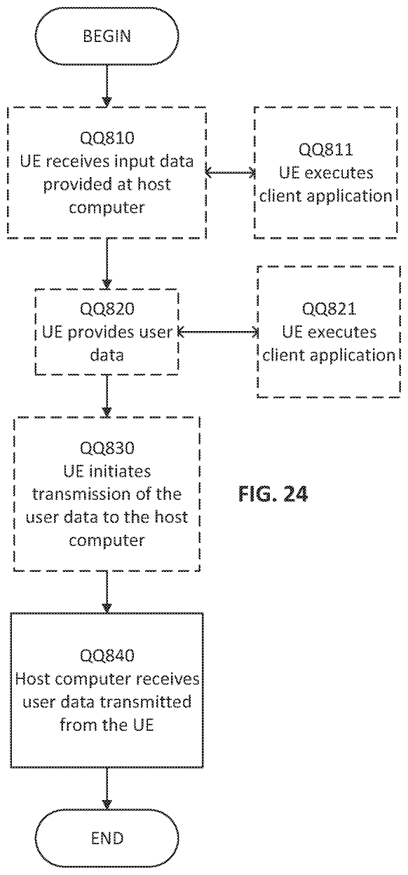

FIG. 24 illustrates methods implemented in a communication system including a host computer, a base station and a user equipment in accordance with some embodiments.

FIG. 24 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 24 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

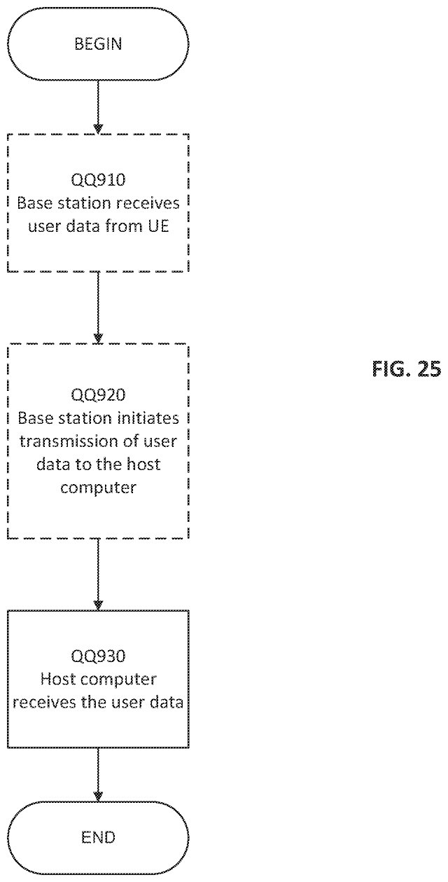

FIG. 25 illustrates methods implemented in a communication system including a host computer, a base station and a user equipment in accordance with some embodiments.

FIG. 25 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 25 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

3GPP 3^{rd} Generation Partnership Project

5G 5^{th} Generation

CDMA Code Division Multiplexing Access

CSI Channel State Information

DCCH Dedicated Control Channel

E-SMLC Evolved-Serving Mobile Location Centre

eNB E-UTRAN NodeB

FDD Frequency Division Duplex

gNB Base station in NR

GSM Global System for Mobile communication

LTE Long-Term Evolution

MBSFN Multimedia Broadcast multicast service Single Frequency Network

MDT Minimization of Drive Tests

MIB Master Information Block

MME Mobility Management Entity

MSC Mobile Switching Center

NR New Radio

OFDM Orthogonal Frequency Division Multiplexing

OSS Operations Support System

O&M Operation and Maintenance

PBCH Physical Broadcast Channel

PDCCH Physical Downlink Control Channel

PDSCH Physical Downlink Shared Channel

PRS Positioning Reference Signal

PSS Primary Synchronization Signal

PUSCH Physical Uplink Shared Channel

RAN Radio Access Network

RAT Radio Access Technology

RNC Radio Network Controller

RRC Radio Resource Control

RS Reference Signal

SON Self Optimized Network

SS Synchronization Signal

SSS Secondary Synchronization Signal

TDD Time Division Duplex

UE User Equipment

UMTS Universal Mobile Telecommunication System

UTRA Universal Terrestrial Radio Access

UTRAN Universal Terrestrial Radio Access Network

WCDMA Wide CDMA

WLAN Wide Local Area Network

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a network node in a communication network, the method comprising:
configuring a time-domain resource reservation for use in communication with a massive machine-type communication, mMTC, communication device when coexisting with a new radio system or a Long-Term Evolution system, wherein the time-domain resource reservation comprises a first bitmap having bits representing the resource reservation in consecutive slots and the first bitmap indicates one of a slot-level resource reservation and a symbol-level resource reservation; and
signaling an indication of the time-domain resource reservation to the mMTC communication device.

2. The method of claim 1, wherein the bits in the first bitmap are arranged in pairs of two-bit patterns, and wherein the two-bit pattern in each pair of bits corresponds to a first slot and a second slot in a single subframe.

3. The method of claim 2, wherein the two-bit pattern of a pair is an indication that resources in the first slot and the second slot in the pair are either both reserved or both unreserved, and wherein the indication applies to all symbols in the first slot and the second slot regardless of whether the first bitmap pertains to the slot-level resource reservation or the symbol-level resource reservation.

4. The method of claim 2, wherein the first bitmap is a slot-level resource reservation having the two-bit pattern of a pair that is an indication that resources in only the first slot or the second slot in the pair are reserved, and wherein the indication applies to all symbols in the first slot or the second slot in the pair, respectively.

5. The method of claim 2, wherein the first bitmap includes a two-level bitmap and comprises a symbol-level resource reservation, and
wherein when the two-bit pattern of a pair in the first bitmap is a first indication that resources in only the first slot in the pair are reserved, the first indication applies to symbols given by a second bitmap of the two-level bitmap, or
wherein when the two-bit pattern of a pair in the first bitmap is a second indication that resources in only the second slot in the pair are reserved, the second indication applies to symbols given by a third bitmap of the two-level bitmap.

6. The method of claim 1, wherein the signaling comprises indicating whether the first bitmap is for the symbol-level resource reservation or the slot-level resource reservation.

7. The method of claim 1, wherein when a time-domain resource is indicated as a reserved resource, the time-domain resource is not available to use for communication with the mMTC communication device.

8. The method of claim 1, wherein communication with the mMTC communication device takes can take place in the time-domain resources indicated as not being reserved.

9. The method of claim 1, wherein the first bitmap comprises a length of 20 bits or 80 bits, the 20 bits or 80 bits indicating reserved resources within 10 ms or 40 ms, respectively.

10. (canceled)

11. The method of claim 1, further comprising:
indicating a combined reservation pattern comprising a leading number of unreserved subframes to be applied before the first bitmap and a trailing number of unreserved subframes to be applied after the first bitmap.

12. The method of claim 11, wherein the leading number of subframes corresponds to an offset for when to apply the pattern indicated by the first bitmap, and the total length of the combined reservation pattern is represented by a periodicity.

13. (canceled)

14. (canceled)

15. A network node comprising:
processing circuitry; and
memory coupled with the processing circuitry, wherein the memory includes instructions that when executed by the processing circuitry causes the network node to perform operations comprising:
configure a time-domain resource reservation for use in communication with a massive machine-type communication, mMTC, communication device when coexisting with a new radio system or a Long-Term Evolution system, wherein the time-domain resource reservation comprises a first bitmap having bits representing the resource reservation in consecutive slots and the first bitmap indicates one of a slot-level resource reservation and a symbol-level resource reservation; and
signal an indication of the time-domain resource reservation to the mMTC communication device.

16. The network node of claim 15, wherein the bits in the first bitmap are arranged in pairs of two-bit patterns, and wherein the two-bit pattern in each pair of bits corresponds to a first slot and a second slot in a single subframe.

17. (canceled)

18. A computer program product comprising a non-transitory storage medium including program code to be executed by processing circuitry of a network node, whereby execution of the program code causes the network node to perform operations according to claim 1.

19. A method of operating a massive machine-type communication, mMTC, communication device in a communication network, the method comprising:
receiving, from a network node, an indication of a time-domain resource reservation for use in communication with the network node, wherein the time-domain resource reservation comprises a first bitmap having bits representing the resource reservation in consecutive slots and the first bitmap indicates one of a slot-level resource reservation and a symbol-level resource reservation; and
communicating with the network node in accordance with the received indication of the time-domain reservation.

20. The method of claim 19, wherein the bits in the first bitmap are arranged in pairs of two-bit patterns, and wherein the two-bit pattern in each pair of bits corresponds to a first slot and a second slot in a single subframe.

21. The method of claim 20, wherein the two-bit pattern of a pair is an indication that resources in the first slot and the second slot in the pair are either both reserved or both unreserved, and wherein the indication applies to all symbols in the first slot and the second slot regardless of whether the first bitmap pertains to the slot-level resource reservation or the symbol-level resource reservation.

22. The method of claim 20, wherein the first bitmap is a slot-level resource reservation having the two-bit pattern of a pair that is an indication that resources in only the first slot or the second slot in the pair are reserved, and wherein the indication applies to all symbols in the first slot or the second slot in the pair, respectively.

23. The method of claim 20, wherein the first bitmap includes a two-level bitmap and comprises a symbol-level resource reservation, and
wherein when the two-bit pattern of a pair in the first bitmap is a first indication that resources in only the first slot in the pair are reserved, the first indication applies to symbols given by a second bitmap of the two-level bitmap, or
wherein when the two-bit pattern of a pair in the first bitmap is a second indication that resources in only the second slot in the pair are reserved, the second indication applies to symbols given by a third bitmap of the two-level bitmap.

24. The method of claim 19, wherein when a time-domain resource is indicated as a reserved resource, the time-domain resource is not available to use for communication with the network node.

25. The method of claim 19, wherein communication with the network node can take place in the time-domain resources indicated as not being reserved.

26. The method of claim 19, wherein the first bitmap comprises a length of 20 bits or 80 bits, the 20 bits or 80 bits indicating reserved resources within 10 ms or 40 ms, respectively.

27. (canceled)

28. The method of claim 19, further comprising:
receiving (1505) an indication from the network node, wherein the indication comprises a combined reservation pattern comprising a leading number of unreserved subframes to be applied before the first bitmap and a trailing number of unreserved subframes to be applied after the first bitmap.

29. The method of claim 28, wherein the leading number of subframes corresponds to an offset for when to apply the pattern indicated by the first bitmap, and the total length of the combined reservation pattern is represented by a periodicity.

30. (canceled)

31. (canceled)

32. (canceled)

33. A massive machine-type communication, mMTC, communication device comprising:
processing circuitry; and
memory coupled with the processing circuitry, wherein the memory includes instructions that when executed by the processing circuitry causes the mMTC communication device to perform operations comprising:
receive, from a network node, an indication of a time-domain resource reservation for use in communication with the network node, wherein the time-domain resource reservation comprises a first bitmap having bits representing the resource reservation in consecutive slots and the first bitmap indicates one of a slot-level resource reservation and a symbol-level resource reservation; and
communicate with the network node in accordance with the received indication of the time-domain reservation.

34. The mMTC communication device of claim 33, wherein the bits in the first bitmap are arranged in pairs of two-bit patterns, and wherein the two-bit pattern in each pair of bits corresponds to a first slot and a second slot in a single subframe.

35. (canceled)

36. (canceled)
